(19) United States
(12) Patent Application Publication
(10) Pub. No.: US 2008/0246593 A1
(43) Pub. Date: Oct. 9, 2008

(54) Sounding lamp for digital equipment

(75) Inventor: Keen Hsu, Taichung (TW)

Correspondence Address: KAMRATH & ASSOCIATES P.A., 4825 OLSON MEMORIAL HIGHWAY, SUITE 245, GOLDEN VALLEY, MN, 55422, US

(73) Assignee: Dong Guan Bright Yinhuey Lighting Co., Ltd., Dong Guan Township Humen Town (CN)

(21) Appl. No.: 11/732,748

(22) Filed: Apr. 4, 2007

(51) Int. Cl. G08B 27/00

(52) U.S. Cl. 340/326

(57) ABSTRACT

A sounding lamp includes a control module, a transmission seat, a connecting interface, a sounding unit, and an illuminating unit. The control module includes a micro control unit, at least one transmission connector, a sound effect control circuit and a light regulation control circuit. Thus, the sounding lamp integrates the sounding and lighting functions. In addition, the sounding lamp is directly connected to a digital equipment by a transmission seat or externally connected to a digital equipment by a connecting interface, thereby enhancing the versatility of the sounding lamp.

### BACKGROUND OF THE INVENTION

1. Field of the Invention

The present invention relates to a lamp and, more particularly, to a sounding lamp available for a digital equipment, such as a MP3 player, IPOD, PDA, cell phone and the like.

2. Description of the Related Art

A conventional lamp comprises an adjustable clamp mounted on a table to attach the lamp onto the table, an arm having a lower end swivelably mounted on the adjustable clamp, a socket mounted on an upper end of the arm, an electric bulb mounted in the socket, and a shade mounted on the socket to cover the electric bulb. Thus, the electric bulb emits light outwardly to provide an illuminating effect. However, the conventional lamp only has a lighting function, thereby decreasing the versatility of the conventional lamp.

### BRIEF SUMMARY OF THE INVENTION

In accordance with the present invention, there is provided a sounding lamp, comprising a control module including a micro control unit, at least one transmission connector connected to the micro control unit, a sound effect control circuit connected to the micro control unit and a light regulation control circuit connected to the micro control unit, a transmission seat connected to the transmission connector of the control module, a connecting interface connected to the micro control unit of the control module, a sounding unit connected to the sound effect control circuit of the control module, and an illuminating unit connected to the light regulation control circuit of the control module.

The primary objective of the present invention is to provide a sounding lamp that integrates the sounding and lighting functions.

Another objective of the present invention is to provide a sounding lamp that is directly connected to a digital equipment by a transmission seat or externally connected to a digital equipment by a connecting interface, thereby enhancing the versatility of the sounding lamp.

A further objective of the present invention is to provide a sounding lamp, wherein the micro control unit of the control module is connected to the transmission seat and the connecting interface and connected to the sounding unit and the illuminating unit, so that the control module integrates the input signals from the transmission seat and the connecting interface and controls the output signals of the sounding unit and the illuminating unit simultaneously, thereby enhancing the working efficiency of the sounding unit and the illuminating unit of the sounding lamp.

A further objective of the present invention is to provide a sounding lamp, wherein the control module integrates the charging, sounding and illuminating functions, so that the sounding lamp has multiple functions, thereby enhancing the versatility of the sounding lamp.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a perspective view of a sounding lamp in accordance with the preferred embodiment of the present invention.

FIG. 2 is an exploded perspective view of the sounding lamp as shown in FIG. 1.

FIG. 3 is a front cross-sectional view of the sounding lamp as shown in FIG. 1.

FIG. 4 is a circuit layout of the sounding lamp as shown in FIG. 1.

### DETAILED DESCRIPTION OF THE INVENTION

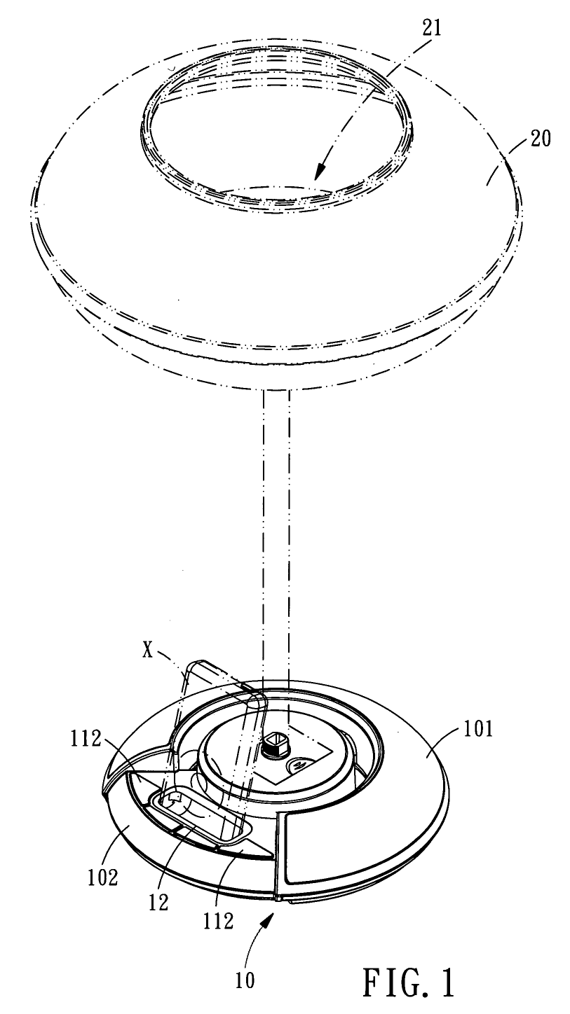

Referring to the drawings and initially to FIG. 1, a sounding lamp in accordance with the preferred embodiment of the present invention comprises a lamp socket 10, a lamp body 20 mounted on the lamp socket 10, an illuminating unit 21 mounted on the lamp body 20, and a power supply (not shown) to supply an electric power to the lamp socket 10, the lamp body 20 and the illuminating unit 21.

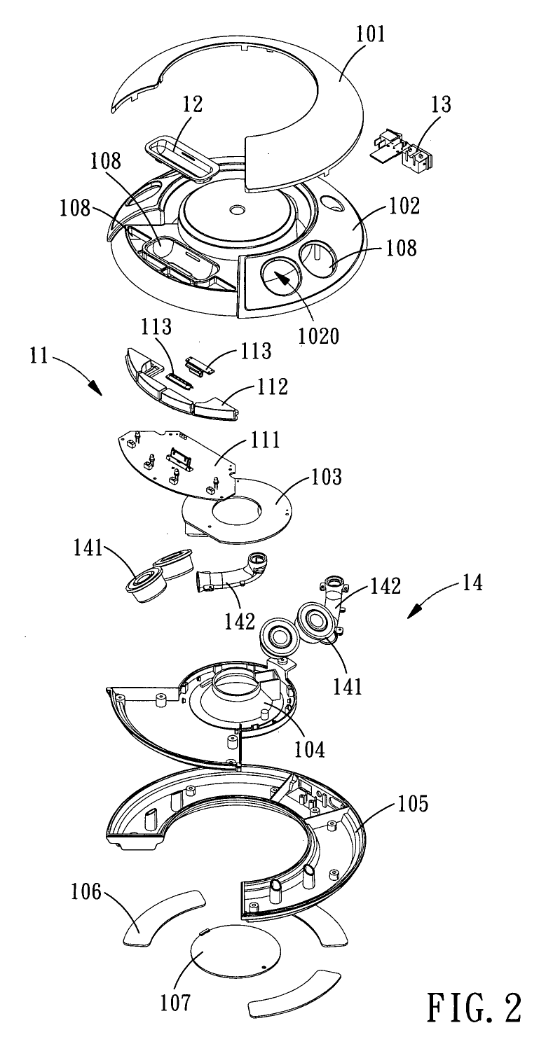

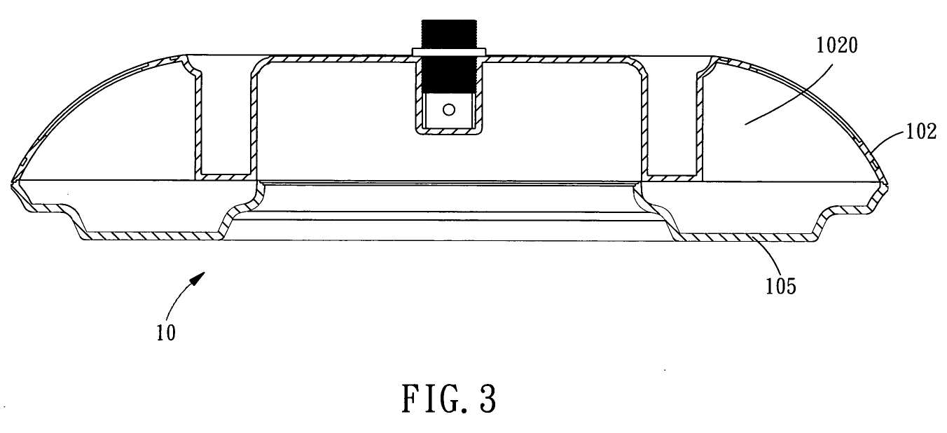

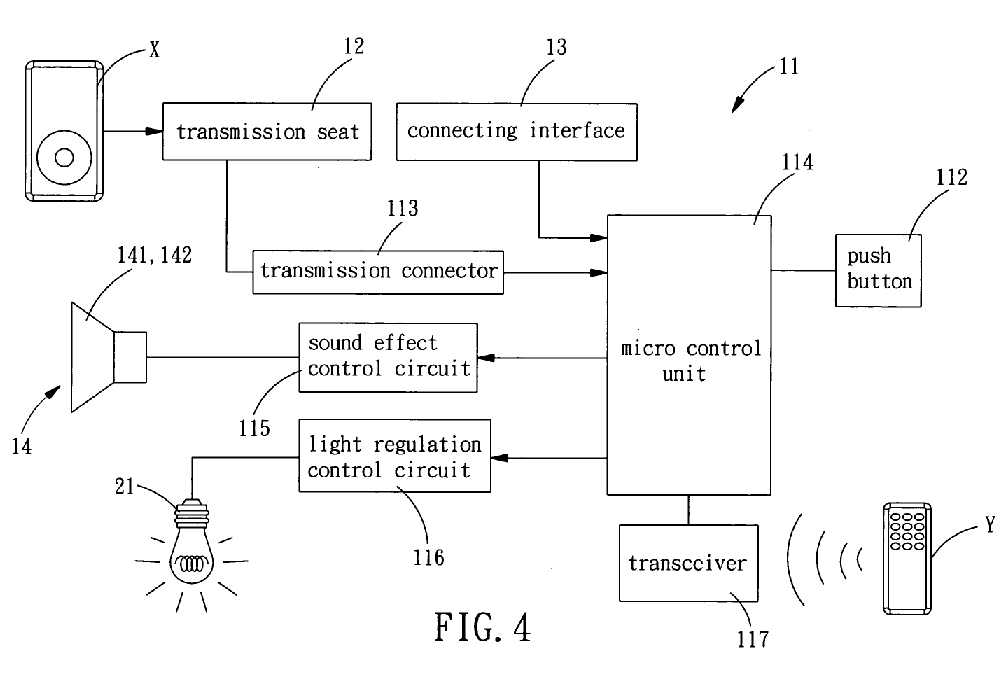

Referring to FIGS. 1-4, the sounding lamp further comprises a control module 11, a transmission seat 12, a connecting interface 13 and a sounding unit 14 each mounted in the lamp socket 10.

The lamp socket 10 includes a top cover 101, a socket body 102, a positioning member 103, a central bottom disk 104, and an outer bottom disk 105. The socket body 102 of the lamp socket 10 has an inside formed with a receiving space 1020. The socket body 102 of the lamp socket 10 has a periphery formed with a plurality of openings 108. The central bottom disk 104 of the lamp socket 10 has a bottom provided with a snapping cover 107. The outer bottom disk 105 of the lamp socket 10 has a bottom provided with a plurality of anti-slip pads 106.

The control module 11 is mounted in the receiving space 1020 of the socket body 102 of the lamp socket 10 and includes a circuit board 111, a plurality of push buttons 112, two transmission connectors 113, a micro control unit (MCU) 114, a sound effect control circuit 115, a light regulation control circuit 116 and a transceiver 117. The push buttons 112 of the control module 11 are mounted in and exposed outwardly from the respective openings 108 of the socket body 102 of the lamp socket 10. The micro control unit 114, the sound effect control circuit 115 and the light regulation control circuit 116 of the control module 11 are mounted on the circuit board 111. The micro control unit 114 of the control module 11 is connected to the push buttons 112, the transmission connectors 113, the sound effect control circuit 115, the light regulation control circuit 116 and the transceiver 117. The light regulation control circuit 116 of the control module 11 is connected to the illuminating unit 21 to control operation of the illuminating unit 21. The transceiver 117 of the control module 11 corresponds to operation of a wireless remote controller “Y”.

The transmission seat 12 is mounted in one of the openings 108 of the socket body 102 of the lamp socket 10 and exposed outwardly from the top cover 101 of the lamp socket 10. The transmission seat 12 is connected to the transmission connectors 113 of the control module 11. The transmission seat 12 is connected to a digital equipment “X” to position and charge the digital equipment “X” and to transmit the signal of the digital equipment “X”.

The connecting interface 13 is mounted in one of the openings 108 of the socket body 102 of the lamp socket 10 and exposed outwardly from the top cover 101 of the lamp socket 10. The connecting interface 13 is connected to the micro control unit 114 of the control module 11. The connecting interface 13 is provided with a USB connector, network connector, sound source signal connector or power switch.

The sounding unit 14 is mounted in the respective openings 108 of the socket body 102 of the lamp socket 10. The sounding unit 14 includes a plurality of speakers 141 and 142 connected to the sound effect control circuit 115 of the control module 11. Thus, the sound effect control circuit 115 of the control module 11 is used to control operation of the sounding unit 14 so as to modulate the voice, mix the signal, sample the signal, compensate the frequency and control the volume of the sounding unit 14.

In operation, referring to FIGS. 1-4, the digital equipment “X” transmits a signal to the transmission seat 12 which transmits the signal to the micro control unit 114 of the control module 11. Then, the micro control unit 114 of the control module 11 integrates the signal from the transmission seat 12 and transmits the integrated signal through the sound effect control circuit 115 to the sounding unit 14 so that the speakers 141 and 142 of the sounding unit 14 can output the integrated signal. At the same time, the sound effect control circuit 115 of the control module 11 is used to control operation of the sounding unit 14 so as to modulate the voice, mix the signal, sample the signal, compensate the frequency and control the volume of the sounding unit 14 simultaneously. Alternatively, other digital equipment (not shown) transmits a signal to the connecting interface 13 which transmits the signal to the micro control unit 114 of the control module 11. Then, the micro control unit 114 of the control module 11 integrates the signal from the connecting interface 13 and transmits the integrated signal through the sound effect control circuit 115 to the sounding unit 14 so that the speakers 141 and 142 of the sounding unit 14 can output the integrated signal. At the same time, the sound effect control circuit 115 of the control module 11 is used to control operation of the sounding unit 14 so as to modulate the voice, mix the signal, sample the signal, compensate the frequency and control the volume of the sounding unit 14 simultaneously.

In such a manner, the sound effect control circuit 115 of the control module 11 is operated by the micro control unit 114 of the control module 11 to control operation of the sounding unit 14. In addition, the light regulation control circuit 116 of the control module 11 is operated by the micro control unit 114 of the control module 11 to control operation of the illuminating unit 21. In addition, the push buttons 112 and the transceiver 117 of the control module 11 are connected to and controlled by the micro control unit 114 of the control module 11 so as to control operation of the sounding unit 14 and the illuminating unit 21. Thus, the control module 11 integrates the charging, sounding and illuminating functions, so that the sounding lamp has multiple functions, thereby enhancing the versatility of the sounding lamp.

Accordingly, the micro control unit 114 of the control module 11 is connected to the transmission seat 12 and the connecting interface 13 and connected to the sounding unit 14 and the illuminating unit 21, so that the control module 11 integrates the input signals from the transmission seat 12 and the connecting interface 13 and controls the output signals of the sounding unit 14 and the illuminating unit 21 simultaneously, thereby enhancing the working efficiency of the sounding unit 14 and the illuminating unit 21 of the sounding lamp. In addition, the control module 11 integrates the charging, sounding and illuminating functions, so that the sounding lamp has multiple functions, thereby enhancing the versatility of the sounding lamp.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. A sounding lamp, comprising:
a control module including a micro control unit, at least one transmission connector connected to the micro control unit, a sound effect control circuit connected to the micro control unit and a light regulation control circuit connected to the micro control unit;
a transmission seat connected to the transmission connector of the control module;
a connecting interface connected to the micro control unit of the control module;
a sounding unit connected to the sound effect control circuit of the control module;
an illuminating unit connected to the light regulation control circuit of the control module.

2. The sounding lamp in accordance with claim 1, further comprising a lamp socket and a lamp body mounted on the lamp socket, wherein the illuminating unit is mounted on the lamp body.

3. The sounding lamp in accordance with claim 2, wherein each of the control module, the transmission seat, the connecting interface and the sounding unit is mounted in the lamp socket.

4. The sounding lamp in accordance with claim 2, wherein the lamp socket includes a top cover, a socket body, a positioning member, a central bottom disk, and an outer bottom disk.

5. The sounding lamp in accordance with claim 4, wherein the socket body of the lamp socket has an inside formed with a receiving space.

6. The sounding lamp in accordance with claim 4, wherein the socket body of the lamp socket has a periphery formed with a plurality of openings.

7. The sounding lamp in accordance with claim 4, wherein the central bottom disk of the lamp socket has a bottom provided with a snapping cover.

8. The sounding lamp in accordance with claim 4, wherein the outer bottom disk of the lamp socket has a bottom provided with a plurality of anti-slip pads.

9. The sounding lamp in accordance with claim 5, wherein the control module is mounted in the receiving space of the socket body of the lamp socket.

10. The sounding lamp in accordance with claim 6, wherein the control module further includes a plurality of push buttons mounted in and exposed outwardly from the respective openings of the socket body of the lamp socket.

11. The sounding lamp in accordance with claim 10, wherein the micro control unit of the control module is connected to the push buttons.

12. The sounding lamp in accordance with claim 1, wherein the control module further includes a circuit board, and the micro control unit, the sound effect control circuit and the light regulation control circuit of the control module are mounted on the circuit board.

13. The sounding lamp in accordance with claim 1, wherein the control module further includes a transceiver corresponding to operation of a wireless remote controller.

14. The sounding lamp in accordance with claim 13, wherein the micro control unit of the control module is connected to the transceiver.

15. The sounding lamp in accordance with claim 1, wherein the transmission seat is mounted in one of the openings of the socket body of the lamp socket and exposed outwardly from the top cover of the lamp socket.

16. The sounding lamp in accordance with claim 6, wherein the transmission seat is mounted in one of the openings of the socket body of the lamp socket and exposed outwardly from the top cover of the lamp socket.

17. The sounding lamp in accordance with claim 1, wherein the transmission seat is connected to a digital equipment to position and charge the digital equipment and to transmit a signal of the digital equipment.

18. The sounding lamp in accordance with claim 6, wherein the connecting interface is mounted in one of the openings of the socket body of the lamp socket and exposed outwardly from the top cover of the lamp socket and is provided with a USB connector, network connector, sound source signal connector or power switch.

19. The sounding lamp in accordance with claim 6, wherein the sounding unit is mounted in the respective openings of the socket body of the lamp socket and includes a plurality of speakers connected to the sound effect control circuit of the control module so that the sound effect control circuit of the control module controls operation of the sounding unit to modulate a voice, mix a signal, sample the signal, compensate a frequency and control a volume of the sounding unit.

20. The sounding lamp in accordance with claim 1, wherein the micro control unit of the control module is connected to the transmission seat and the connecting interface and connected to the sounding unit and the illuminating unit, so that the control module integrates input signals from the transmission seat and the connecting interface and controls output signals of the sounding unit and the illuminating unit simultaneously.
